(19) United States
(12) Patent Application Publication
(10) Pub. No.: US 2025/0021350 A1
(43) Pub. Date: Jan. 16, 2025

(54) Method, System & Computer Program Product for Method for Encoding a State Machine for Execution in a Distributed Ledger

(71) Applicant: AVC Innovations LLC, SPEARFISH, SD (US)

(72) Inventors: Bob G. Schlicher, Knoxville, TN (US); David J. Todd, Spearfish, SD (US); Niels C. Skjoldager, Redington Beach, FL (US)

(73) Assignee: AVC Innovations LLC, SPEARFISH, SD (US)

(21) Appl. No.: 18/600,622

(22) Filed: Mar. 8, 2024

Related U.S. Application Data
(60) Provisional application No. 63/526,979, filed on Jul. 14, 2023.

(51) Int. Cl. G06F 9/448; G06F 8/30

(52) U.S. Cl. CPC G06F 9/4498; G06F 8/313

(57) ABSTRACT

A method, system, computer program product of providing a FiniteStateMachine (FSM) with embedded business rules, processing data & events, where each state is individually saved to blockchain ledger, a data record including a unique identifier/name, a set of input field(s) or input data slots, state rules in a rule language, and set of output field names or output data slots, method including: executing of a Smart Contract by identifying state by id or name, loading corresponding Component State from blockchain, adding/executing code for processing the State's behavior, where the code includes rules for the state in the rule language (e.g., but not limited to. Open Policy Agent, Rego, Prolog, DataLog, RuleML, Drools Rule Language, NRules, and JavaScriptObjectNotation(JSON), etc.). System includes processor(s), application program interface (API(s)) for communicating, blockchain, rule processor, and memory. This enhances transparency, immutability, and secure execution of business rules within FSM architecture.

### BACKGROUND OF THE DISCLOSURE

### Field of the Disclosure

The disclosure relates generally to contracts, and more particularly to smart contract systems.

### Related Art

The reader is directed to U.S. Pat. No. 7,716,619 entitled “Distributable and Serializable Finite State Machine,” to Braceras, et al., the contents of all of which is incorporated herein by reference in its entirety.

The reader is further directed to U.S. Pat. No. 10,789,239 entitled, “Finite State Machine Distributed Ledger,” to Ventura et al., the contents of all of which is incorporated herein by reference in its entirety.

The reader is further directed to US Patent Publication No. US20190279197A1 entitled, “Systems and Methods for Implements Deterministic Finite Automata (DFAS) via Blockchain,” to Wright, et al., the contents of all of which is incorporated herein by reference in its entirety.

Conventional systems need improvement. Improved systems that overcome shortcomings of the conventional systems are needed.

### SUMMARY OF THE INVENTION

According to one example embodiment, a computer implemented method of providing a finite state machine (FSM) 138 with business rules embedded for processing data and at least one event, may include at least one electronic computer processor of a system coupled to at least one electronic memory storage device and coupled via at least one communications network interface to at least one data communications network, the method may include: individually saving, by the at least one electronic computer processor, to at least one blockchain ledger each state of a plurality of states as a data record, wherein the each state may include at least one or more of: a unique identifier or name for the state, a set of one or more input field names called input data slots, the rules for the state written in a rule language, and a set of one or more output field names called output data slots; executing, by the at least one electronic computer processor, of a smart contract may include at least one or more of: processing, by the at least one electronic computer processor, for the state of the FSM 138 by identifying the state by id or by name, loading, by the at least one electronic computer processor, a corresponding component state from the at least one blockchain ledger, or adding and executing, by the at least one electronic computer processor, code for processing behavior of the corresponding component state, wherein the code includes rules for the state written in a rule language; employing, by the at least one electronic computer processor, at least one rule language comprising at least one rule comprising, in some embodiments, e.g., but not limited to, at least one or more of, e.g., and not limited to: Open Policy Agent (OPA), Rego, Prolog, Prolog-based DataLog, RuleML, Drools Rule Language (DRL), NRules, or JavaScript Object Notation (JSON), etc.; and/or in some embodiments, wherein the system may include at least one or more of: the at least one electronic computer processor, at least one application program interface (API) for a user to communicate, the at least one blockchain ledger, at least one rule processor, or the at least one electronic memory storage device, according to an example embodiment.

According to another example embodiment, a system of providing a finite state machine (FSM) with business rules embedded for processing data and at least one event, the system may include: at least one electronic computer processor, coupled to at least one electronic memory storage device and coupled via at least one communications network interface, coupled to at least one data communications network, the system may include wherein said at least one electronic computer processor is configured to: individually save to at least one blockchain ledger each state of a plurality of states as a data record, wherein the each state may include at least one or more of: a unique identifier or name for the state, a set of one or more input field names called input data slots, the rules for the state written in a rule language, and a set of one or more output field names called output data slots; executing of a smart contract may include configuring the system to at least one or more of: process for the state of the FSM 138 by identifying the state by id or by name, load a corresponding component state from the at least one blockchain ledger, or add and execute code for processing behavior of the corresponding component state, wherein the code includes rules for the state written in a rule language; employ at least one rule language comprising at least one rule comprising, e.g., but not limited to, at least one or more of, e.g., and not limited to: Open Policy Agent (OPA), Rego, Prolog, Prolog-based DataLog, RuleML, Drools Rule Language (DRL), NRules, or JavaScript Object Notation (JSON), etc.; and where the system may include at least one or more of: the at least one electronic computer processor, at least one application program interface (API) for a user to communicate, the at least one blockchain ledger, at least one rule processor, or the at least one electronic memory storage device, according to an example embodiment.

According to yet another example embodiment, an example computer program product embodied on a computer accessible nontransitory storage medium, including at least one instruction, which when executed on at least one electronic computer processor performs a method of providing a finite state machine (FSM) with business rules embedded for processing data and at least one event, may include at least one electronic computer processor coupled to at least one electronic memory storage device and coupled via at least one communications network interface to at least one data communications network, the method may include: individually saving to at least one blockchain ledger 114 each state of a plurality of states as a data record, wherein the each state may include at least one or more of: a unique identifier or name for the state, a set of one or more input field names called input data slots, the rules for the state written in a rule language, and a set of one or more output field names called output data slots; executing of a smart contract may include at least one or more of: processing for the state of the FSM 138 by identifying the state 126-134 by id or by name, loading a corresponding component state 116-122, from the at least one blockchain ledger 114, or adding and executing code 104 for processing behavior of the corresponding component state 106, wherein the code includes rules for the state written in a rule language; employing at least one rule language may include at least one rule comprising, e.g. but not limited to, at least one or more of, e.g., and not limited to: Open Policy Agent (OPA), Rego, Prolog, Prolog-based DataLog, RuleML, Drools Rule Language (DRL), NRules, and/or JavaScript Object Notation (JSON), etc.; and where the system may include at least one or more of: the at least one electronic computer processor, at least one application program interface (API) for a user to communicate, the at least one blockchain ledger, at least one rule processor, or the at least one electronic memory storage device, according to an example embodiment.

Example embodiments of the claimed invention relate to computing and system architecture of a finite state machine 138 for users to transmit records to a blockchain148, 150, according to an example embodiment. The system may include, e.g., but not limited to, comprise of, or consist of, smart contracts for execution of business rules, re-programmable language, and/or containers to facilitate access of latest data, etc. according to an example embodiment.

The finite state machine (FSM) 138 may include, may be comprised of, or consist of, in one example embodiment, a finite collection of stateless states; each state may be deployed as an independent operating service that may contain business rules for its assigned state of the FSM, according to an example embodiment. A rule engine 306 may execute the business logic by combining inbound event data from 152, 154, 156 with the existing data assigned in the rule engine input data slots, according to an example embodiment. The rule engine 306 may include a component 106 of the smart contract 102 that can assign the data to the data slots, according to an example embodiment. In another example embodiment, the smart contract 102 can contain or integrate the rule engine 306 where the smart contract 102 may control a data flow assigning the data to the data slots and executing the rule engine 306 to execute the rules where the rule engine 306 may execute in a separate process that may execute in a separate electronic computer processor and the smart contract 102 obtains the results from the rule engine 306, according to one example embodiment. Each state, containing the business rules, may be essentially a document that may be stored as a record in the blockchain ledger 114 where it may be assigned a unique id 9, 11, 21, 22, etc., as shown, and along with metadata that may describe the document, according to an example embodiment.

The production rules of the smart contract 102 may be automatically executed when the state of data is detected to meet pre-defined and encoded conditions for those rules, according to an example embodiment. When the rule or rules are satisfied to meet these conditions, the smart contract executes specific actions and events for those rules, according to an example embodiment.

Production rules are typically written in a rule language that is a scripting language independent of the software application code, such as that of the smart contract code, according to an example embodiment. These production rules can be stored in different data record storage technologies including databases that may include, e.g., but not limited to, SQL and NoSQL databases, blockchain ledgers, and inside of files saved to a file system, etc., according to an example embodiment.

The rule engine 306 for the business rule may be embedded within each state of the FSM 138, according to an example embodiment. The business rules may provide the logic, processes events, which may be received by event receiver 154 and queued by event queue 156, under specific conditions, publish a state to the blockchain as the new block, and other actions. These actions or events are terms already negotiated between parties, according to an example embodiment. The rule set and operation of the FSM can be tested and verified in an environment independent of the blockchain using tools such as Rego Playground, Drools, POA, or other related applications, according to an example embodiment. These tools provide the businessperson or creator of the business rules with a software capability to perform a variety of options, including translating terms into code, creating and editing rules, maintaining version control and reporting, and other management features, according to an example embodiment. The business rules may be a construct of business practices or represent a negotiated contract between parties, according to an example embodiment. The advantage of the rule set is the ability to separate or retain the rules and apply them to evolving information technology systems, infrastructure, middleware such as cloud services, cyber security, and containers, according to an example embodiment.

In this embodiment, production or inference rules are the type of business rules employed, according to an example embodiment. A production rule may be structured using first-order logic with reasoning represented in if-then or when-then format, according to an example embodiment. Production rules can be stored in a database and these rules are independent of the underlying software application code, according to an example embodiment. These production rules operate in a stateless manner and execute when a user or application invokes them, according to an example embodiment. The Rule Engine 306 may perform rapid pattern matching of the facts and data against the rules, according to an example embodiment. The Engine 306 may conform to the logic pattern as dictated in the business rules, according to an example embodiment; in this embodiment, the Rete algorithm may be employed for the rule engine to perform the pattern matching and logic reasoning, according to an example embodiment.

For example, according to an example embodiment, the business rules reflect the transaction between a buyer and supplier in shipping cargo, and may be written in the ledger, according to an example embodiment. The smart contract 102 may automatically execute the costs of shipping an item, addition of taxes and shipping fees, price reduction for expedited arrival, and payment to supplier when buyer receives the shipment, or other material terms agreed to between the buyer and supplier, according to an example embodiment.

In this embodiment, a private and permissioned blockchain may enforce identity management and may restrict access to interested parties, according to an example embodiment. Hyperledger Fabric (HLF) may be a distributed ledger with all transactions committed to the network, and smart contracts 102 also called chaincodes may be embedded in the blockchain for users to manage their transactions. Members of the HLF network may be enrolled through a membership service provider (MSP), and actions 160 or events committed to the blockchain may require protocols such as, e.g., but not limited to, proof of work, according to an example embodiment. The immutability characteristic of the blockchain may guarantee no modification of a transaction added to the blockchain, which is done using cryptographic techniques, according to an example embodiment. The blockchain ecosystem may include nodes, and the nodes may be assigned to permissioned participants, also referred to as peers, according to an example embodiment. The blockchain nodes 150, may use smart contracts 102 to provide controlled access to the private distributed ledger 114 and for consistent protocols for updating and accessing ledger information, according to an example embodiment.

Unlike the smart contract 102 embedded in the state machine 138 with the business rules, the smart contracts 102 implanted for HLF may be invoked by an event or stimulus external to the blockchain, according to an example embodiment. Conceptually, chaincode is synonymous with smart contract 102 and may be used explicitly for HLF, according to an example embodiment. Usually, the chaincode may interact with the world state 110 to perform action(s) 160 and may query the latest information and does not directly interact with the blockchain ledger 114, according to an example embodiment. In this embodiment, the programming language for chaincode may include, e.g., but not limited to, Golang, JavaScript, and Java, etc., with respective chaincode libraries, according to an example embodiment.

In this embodiment, the rule engine 304 may not be constrained within the access limits of an executing HLF smart contract, according to an example embodiment. Thereby, the rule engine 304 may perform a chaincode-to-chaincode invocation or cross-channel record access to extend or connect with the HLF programming, according to an example embodiment. Although a state created by smart contract 102 or chaincode is not directly accessible by another chaincode, a credentialed user including a rule engine program of HLF may gain access since all are within the same HLF network and those credentials are valid for the channels for the chaincode, according to an example embodiment. Each state of an FSM 138 may be saved as a separate data record in the blockchain, according to an example embodiment. This data record may be comprised of state data and may include the rules for the state written in a rule language that can be loaded and executed in the Smart Contract 102, according to an example embodiment. During the execution of a Smart Contract 102 that may include FSM code 104, the FSM code 104 may be identified and obtained by the Smart Contract 102 from the matched data record, according to an example embodiment. The FSM code 104 may be loaded into the Component State Engine 106 and may be executed by the Smart Contract 102. After the Smart Contract 102 has completed its execution, the Component State Engine 106 data contents may be cleared of the FSM code 104 that was loaded, according to an example embodiment. In this manner, another FSM code 104 can be loaded as required to fulfill the processing for the next transaction, according to an example embodiment.

The engine 304 may manage the decision process using pre-defined logic to reach an outcome, according to an example embodiment. As agreed to by the blockchain peers, according to an example embodiment, the consensus protocol may be essential to a new block added to the blockchain, and it may provide reliability to the distributed computing environment, according to an example embodiment. Within the system, the current value of the state can be accessed through the World State 110 of the HLF system or the blockchain, according to an example embodiment. The aptitude of the ledger 114 may be facilitated by using the World State 110 that may hold the current values of the states instead of accessing the blockchain, according to an example embodiment, which would require calculating the transaction on the blockchain, according to an example embodiment. Furthermore, the World State 110 may receive queries from smart contracts 102 and other requests for the most recent entries while prior entries for the exact match can be accessed in the blockchain, according to an example embodiment.

In this embodiment, with off-chain storage, the data including the rules in their rule language format may be stored off-chain in a separate data storage from the blockchain that may include, e.g., but not limited to, a database or one of more files, according to an example embodiment. The computed hash code of the same data may be stored on-chain in the blockchain ledger 114, according to an example embodiment. Data retrieved from the off-chain storage may be validated to ensure no alterations occurred by computing the hash of the data from the storage and comparing with the prior computed hash stored in blockchain ledger 114, according to an example embodiment. And prior to the deployment of the state to the blockchain, the smart contract 102 within the finite state machine 138 may execute the business rules and may assign the states 126-134 to the public blockchain 116-122, which is a considered automated, according to an example embodiment. Each state of the state machine 138 may be a component 106, 108 with a unique module of code and instruction that may receive input data from the rules and outside state, according to an example embodiment, then 1) a unique identifier or key may be assigned for each state, according to an example embodiment, 2) the appropriate rules to relevant state may be assigned, according to an example embodiment 3) the data inputs for transaction events and the application database may be assigned, according to an example embodiment and 4) action(s) 160a, 160b, 160c (160) may be identified for all results and outputs generated from the rules, according to an example embodiment.

The deployer 142, according to an example embodiment, may convert the business rules into a JSON format, which may conform to a readable language by the distributed ledger as illustrated in blockchain node FSM-enabled 150, e.g., both the World State 110 and blockchain 114, according to an example embodiment. The versatility of JSON format may allow the JSON message to be acknowledged easily between computers and program languages, according to an example embodiment. Additionally, the deployer 142 may produce a matrix that may include a rule set for transition between states 124 and 136, as shown in FSM 138 and may include the unique identifiers or key for each state of the finite state machine 138, according to an example embodiment.

The module of code and instructions may be compressed and/or may be packaged into a JSON message format that may conform with the example Blockchain data storage, thus forming the Component State JSON Document, according to an example embodiment. The deployer 142 may also produce the state transition matrix that contains the business rule set for state changes and the identifiers or keys for each component state of the FSM 138, according to an example embodiment. The deployer 142 may send a transaction request to the blockchain integration API 146, according to an example embodiment. The Blockchain Integration API 146 may authenticate with the blockchain network 148, as shown in the illustration of FIG. 1, according to an example embodiment.

The summary detailed above is not intended to be an exhaustive representation of every embodiment or aspect of this invention. Instead, the summary provides a mere example and description of concepts and features set forth in this invention. In combination with the diagrams, the features, ideas, and summary provide representative modes to carry out this disclosure, according to an example embodiment. This disclosure expressly includes any and all combinations and sub-combinations of the elements and features presented above and below, according to an example embodiment.

### BRIEF DESCRIPTION OF THE VARIOUS EXAMPLE VIEWS OF THE DRAWINGS

This present disclosure will be fully understood with reference to the following detailed description when taken in conjunction with the figures, herein:

FIG. 1 is a flowchart showing a method for coding state machine and rules, according to an exemplary embodiment;

FIG. 2 is a process flow diagram corresponding to the FIG. 1 and describes a process for assigning component states to the blockchain, according to an exemplary embodiment;

FIG. 3 is a schematic view depicting various state engine components that execute the business rules found in each state of the FSM, according to an exemplary embodiment;

FIG. 4 is a flowchart showing a process for executing the finite state machine in the blockchain, according to an exemplary embodiment;

FIG. 5 depicts an example embodiment of an example component level example hardware architecture for an example computing device as may be used for any of various example hardware subsystem components of an example system, according to one example embodiment; and

FIG. 6 depicts an example embodiment illustrating an example system level hardware architecture for an example application server, web server embodiment of an example service provider system for providing an example software architecture of various example subsystem components of an example networking system, which may be used to implement, according to one example embodiment.

### DETAILED DESCRIPTION OF VARIOUS EXAMPLE EMBODIMENTS OF THE INVENTION

The various embodiments of the invention described herein should not be limited to the description, even with reference to the accompanying figures and drawings depicted, but only with respect to the claims. The invention may be embodied in different forms and should not be restricted as set forth here.

The various embodiments of the invention described herein should not be limited to the description, even with the reference to the accompanying figures and drawings depicted herein, according to an example embodiment. The invention may be embodied in different forms and should not be restricted at set forth, according to an example embodiment. The following provides a logical view of the system, according to an example embodiment.

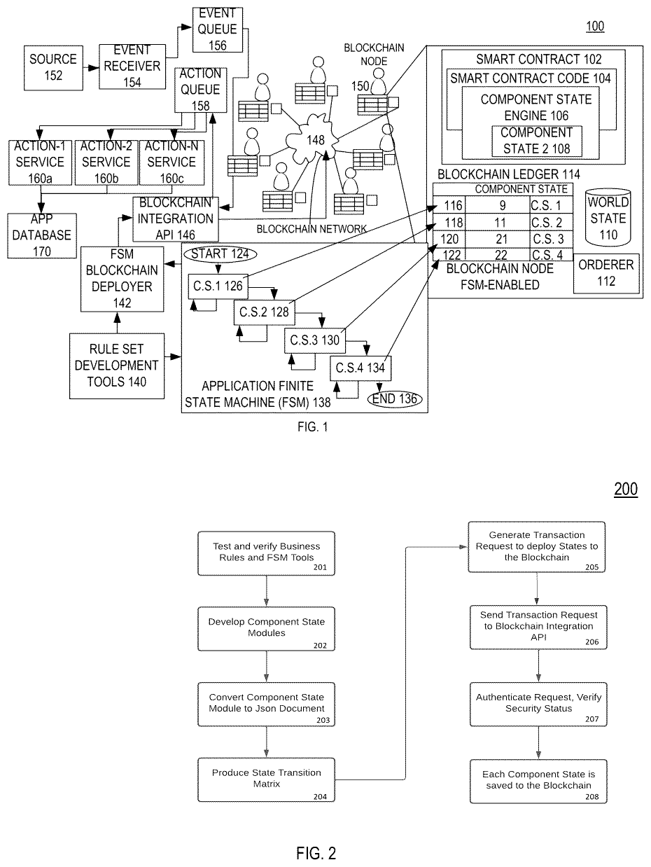

FIG. 1 is a flowchart 100 showing an example method for coding state machine 138 and rules 140, according to an exemplary embodiment, discussed further below.

FIG. 2 is a process flow diagram 200 corresponding to the FIG. 1 and describes a process for assigning component states to the blockchain, according to an exemplary embodiment, discussed further below.

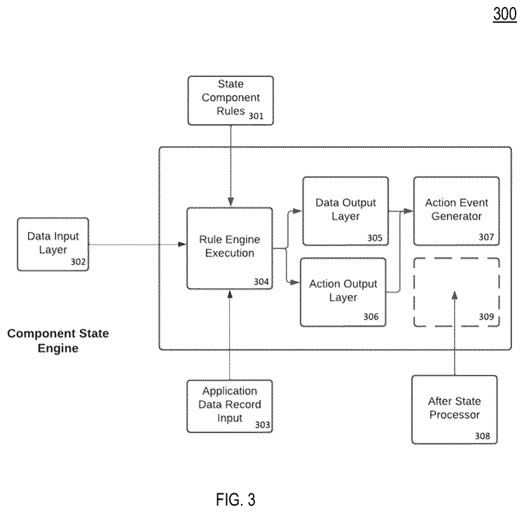

FIG. 3 is a schematic view 300 depicting various state engine components that execute the business rules found in each state of the FSM, according to an exemplary embodiment, discussed further below.

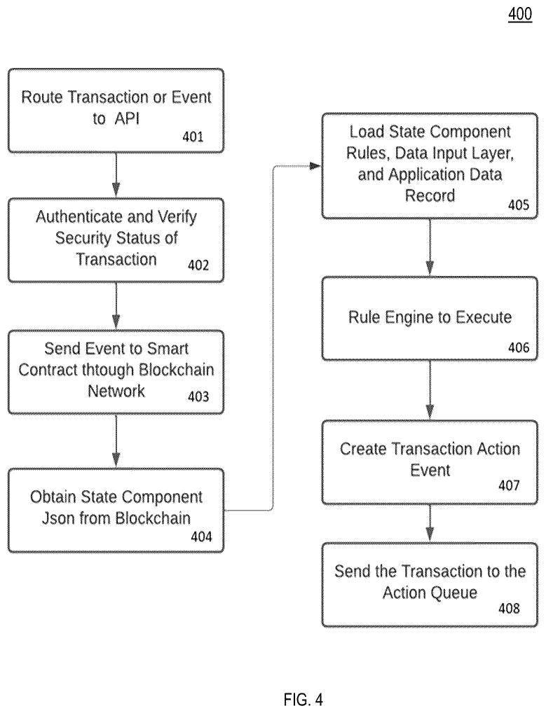

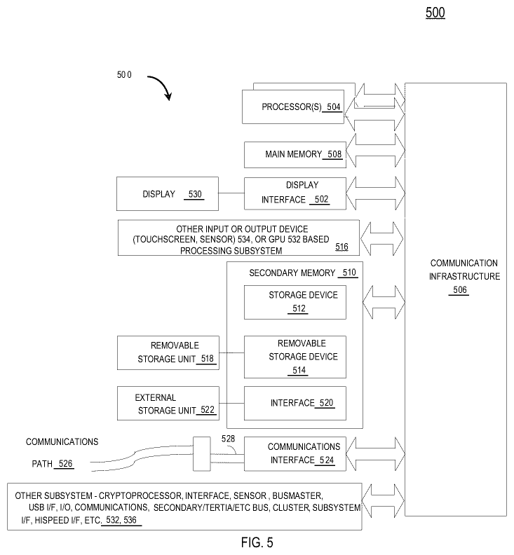

FIG. 4 is a flowchart 400 showing a process for executing the finite state machine in the blockchain, according to an exemplary embodiment, discussed further below.

FIG. 5 depicts an example embodiment of an example component level example hardware architecture 500 for an example computing device as may be used for any of various example hardware subsystem components of an example system, according to one example embodiment, discussed further below.

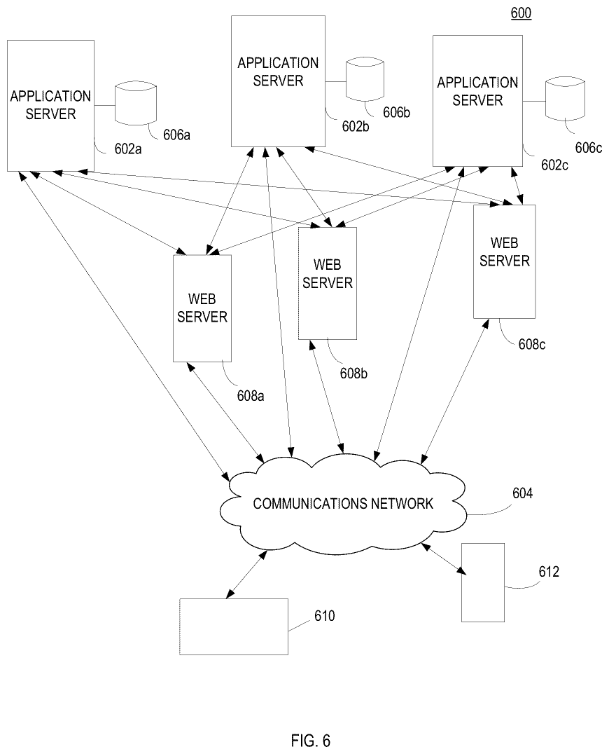

FIG. 6 depicts an example embodiment illustrating an example system level hardware architecture 600 for an example application server, web server embodiment of an example service provider system for providing an example software architecture of various example subsystem components of an example networking system, which may be used to implement, according to one example embodiment, discussed further below.

FIG. 1 provides an illustration for the parts of the disclosed method involving coding the State Machine 138 and Rules 140, assigning each Component State to the Blockchain 114, processing a received event in the Blockchain Smart Contract 102, and performing after actions 160a, 160b, 160c (collectively 160), in an action queue 158 such as sending out notifications and/or other actions 160 as may act on app database 170, after the Smart Contract 102 has completed its processing (e.g., of smart contract code 104 and/or performance of component state engine 106, 138, world state 110, and orderer 112) and assignments, according to an exemplary embodiment.

In FIG. 1, a Party (user or end user, performing the process as shown) at an example system user interface (UI) may, e.g., but not limited to, use the Rule Set Development Tools 140, shown in the lower right, to write the business rules (e.g., as illustrated by the state transition arrows, etc.) and the FSM 138 for their application, according to an exemplary embodiment. Using these example rule set development Tools 140, the Party can, e.g., but not limited to, test and verify the operation of the example State Machine 138 and the Rule Sets with an example 3rd Party tool without any design or library dependency on the Blockchain 114 and/or the distributed computing environment, as illustrated by the example blockchain network 148 of a plurality of example nodes 150 (only one example node is specifically labeled in detail for illustration), according to an exemplary embodiment. The Rule Set can be in different data and file formats written in a Rule Engine language such as RuleML (available from ruleml.org, the RuleML Technical Committee from the Oasis-Open organization, RuleML Inc. non-profit organization), DRL (Drools Rule Language, rules are defined in .drl text files, available from drools.org), and Rego (policy language available from openpolicyagent.org open policy agent is an open-source engine providing a way of declaratively writing policies as code and using those policies as part of a decision-making process, rego is a policy language), according to an exemplary embodiment. To deploy the business rules to the blockchain ledger, the Party uses the FSM Blockchain Deployer 142, illustrated in the lower right of FIG. 1, according to an exemplary embodiment. The FSM packages the Rule Set 140 and may engage the blockchain system 148, 150, 114 through the Blockchain Integration API 146 to install the Rule Set into the Blockchain Ledger 114 as shown in the right side of FIG. 1, according to an exemplary embodiment. After the Rule Set may be installed, the API notifies the Smart Contract 102 in the Blockchain Node 150 of the installed Rule Set 116, 118, 120, 122 in the Ledger, according to an exemplary embodiment.

In 152, when Events may be received from an example data source 152, and may be provided to event receiver 154, as shown in the left side of the diagram 100, the event may be queued in event queue 156 and may be sent through the Blockchain Integration API 146 to the Smart Contract 102, according to an exemplary embodiment. The Smart Contract 102 may assign the data received in the event 154, 156 to data slots of the Component State Engine 106 where the data (e.g., but not limited to, of an example component state 2 108 corresponding to element 11 Component state 2 118 of blockchain ledger 114), may be evaluated based on the Rule Set, according to an exemplary embodiment.

In FIG. 2, the process flow diagram corresponding to the FIG. 1, describes the following process description for assigning Component States 116-122 to the Blockchain 114, according to an exemplary embodiment.

FIG. 2 may include an illustration diagram 200 including an example flow diagram 200 including, e.g., but not limited to, creating and adding states of the FSM 138 to the distributed ledger 114, as shown in FIGS. 1 and 2, after the business rules may be written and the appropriate application for the FSM 138 may be selected, and may be seen in diagram 200 with reference to diagram 100, according to an exemplary embodiment.

In 201, prior to adding a state 116-122 to the ledger 114, the business rules and tools of the FSM 138 may be tested and verified may include testing and verifying business rules and FSM tools including rule set development tools 140, as shown in 201, and from 201, flow diagram 200 may continue with 202, according to an exemplary embodiment.

In 202, the business rules and input data for each state may be crafted into individual component state that may be assigned with unique identified or key may include developing component state modules, as shown in 202, and from 202, flow diagram 200 may continue with 203, according to an exemplary embodiment.

In 203, the language of the code and instructions in the state may be compressed into a JSON format, which may conform to the distributed ledger 114 may include converting a component state module to example JSON document, as shown in 203, and from 203, flow diagram 200 may continue with 204, according to an exemplary embodiment. The application or business code may be written in language for smart contract code language, e.g., but not limited to, Go, JavaScript, Java and the rule language, e.g., but not limited to, Rego, Prolog, BR-rules, according to an exemplary embodiment.

In 204, in addition to transitioning to JSON document, a matrix may be produced or develop with the business rules for state changes and identifier keys for each state of the FSM, may include producing a state transition matrix, as shown in 204, and from 204, flow diagram 200 may continue with 205, according to an exemplary embodiment.

In 205, built within the rules, a request for integration to blockchain may be sent to add states to the ledger, it may generate a transaction request to deploy states, using FSM blockchain deployer 142, to the blockchain as set forth in 205, and from 205, flow diagram 200 may continue with 206, according to an exemplary embodiment.

In 206, this transaction request may be made through the API to the blockchain node or network may include sending a transaction request to blockchain integration API 146, as shown in 206, and from 206, flow diagram 200 may continue with 207, according to an exemplary embodiment. The request may be authenticated by the peers or operators of the nodes, according to an exemplary embodiment.

In 207, upon consensus of the peers for approval of the request via the consensus protocol may include authenticating the request, verifying security status, as shown in 207, and from 207, flow diagram 200 may continue with 208.

In 208, the state in the JSON format may be added to the distributed ledger with all nodes having a copy may include each component state being saved to the blockchain as shown in 208, and from 208, flow diagram 200 may immediately end, according to an exemplary embodiment. The order of the states on the blockchain 114 may be dictated by the business rules, in essence the order aligns to how the states may be depicted in the finite state machine 138, according to an exemplary embodiment. And the order that the states may be saved on the blockchain 114 does not impact the execution of smart contracts 102 of the states, according to an exemplary embodiment.

The business rule and inputs, along with other factors may be a function of the smart contract 102 in the process to add the state to the blockchain 114, according to an exemplary embodiment.

FIG. 3 may include a block diagram 300, which may include an illustration of these factors and associated actions; until these core functions may be present the smart contract 102 cannot process the JSON format, according to an exemplary embodiment.

The rule engine 304 may perform the computation and evaluations of the state component rules 301 and can include executable code in JSON format as illustrated in 301, example input data (including, e.g., but not limited to, from data input layer 302 and/or application data record input 303) from external transactions where the API may receive the data as shown in 302, and application data record input 303, which may include a data record which may contain business rules that may be subject to FSM evaluations, may be retrieved from a database and tools of the FSM 138, as shown in 303, according to an exemplary embodiment.

The example outputs of rule engine may be split with the data may be stored in the share memory called the data output layer 305 and the prescribed actions may be stored in the shared memory called action out layer 306, according to an exemplary embodiment. The data output layer 305 and the action output layer 306 may be combined as a transaction event that may be fed into a queue for the action event generator 307 as illustrated in 300, for downstream processing, according to an exemplary embodiment.

The after-state processor 308 may determine, e.g., the state transition, may perform update saves to the data records and other operations such as, e.g., but not limited to, logging, posting an activity transaction to the blockchain 114, and notifications as required, according to an exemplary embodiment.

The After State Processor 308 may contain, e.g., but not limited to, the state transition matrix, which may transition into the smart contract 102 of the component state engine 106, 300, as shown in 309, according to an exemplary embodiment. During the smart contract 102 run-time operations, the after-state processor 308 can be cached into, e.g., but not limited to, local memory to improve performance and/or to eliminate the transaction latency with retrieving it from the blockchain 114, for all the component state transactions, according to an exemplary embodiment.

FIG. 4 illustrates an example flow diagram 400, which may include, after the transaction or event may be completed, the transaction or event may be transmitted to the blockchain 114 as the subsequent block, using a process as illustrated in an example of diagram 400 of FIG. 4, according to an exemplary embodiment. In 401, the transaction or event may be routed through the blockchain integration API 146, may include routing transaction or event to API as shown in 401, from 401, flow diagram 400 may continue with 402, according to an exemplary embodiment.

In 402, after authenticating and verifying, the blockchain API may communicate through the secured blockchain network to the smart contract 102 that was developed for the states of the FSM may include authenticating and/or verifying security status of transaction as shown in 402, from 402, flow diagram 400 may continue with 403, according to an exemplary embodiment.

In 403, the smart contract 102 may extract data and may obtain the corresponding application data record from the transaction may include sending event to smart contract 102 through the blockchain network 148 as shown in 403, from 403, flow diagram 400 may continue with 404, according to an exemplary embodiment.

In 404, the smart contract 102 may use that data of the state component to query and obtain the corresponding state component JSON document from the distributed ledger 114, may include obtaining state component JSON from blockchain 114 as shown in 404, from 404, flow diagram 400 may continue with 405, according to an exemplary embodiment.

The smart contract may process the JSON Document by decompressing and navigating its contents, and extract the contained rule set as shown in 404, according to an exemplary embodiment.

In 405, in addition to the rule set assigned to the Rule Engine 304, the data input layer 302, and the application data record 303 may be loaded respectively and may include loading state component rules 301, data input layer 302 and application data record input 303 as shown in 405 and illustrated in 300, then the rule engine 304 may execute in 406, from 405, flow diagram 400 may continue with 406, according to an exemplary embodiment.

In 406, the rule engine 304 may assign its computing results to the output layers for data 305 and action 306, may include using the rule engine 304 to execute as shown in 406, and from 406, flow diagram 400 may continue with 407, according to an exemplary embodiment.

In 407, the action event generator 307 of 300 of the smart contract 102 may create a transaction action event from the contents in the output layers and may include creating a transaction action and event as shown in 407, from 407, flow diagram 400 may continue with 408, according to an exemplary embodiment.

In 408, the smart contract 102 may send the transaction of the event to the event queue 156 as shown in 408, according to an exemplary embodiment. Once in the Action Queue 158 may include sending the transaction to the action queue 158, as shown in 408, the event can be routed to perform one of many action services, from 408, flow diagram 400 may immediately end, according to an exemplary embodiment. The service that may be performed may originate from the rule engine 304 of the smart contract 102 as illustrated in 300 Rule Engine 304 may execute the rules on data, according to an exemplary embodiment.

FIG. 5 depicts an example embodiment of a hardware architecture block diagram 500 for an example computing or communications device as may be used for any of various example component state engine machines, data input layer, rule engine execution machine, state component rules device, data output layer component, action output layer component, action event generator component, after state processor, application data record device, example smart contract device, blockchain ledger, world state, orderer device, blockchain node FSM-enabled device, source device, event receiver device, event queue device, action queue device, blockchain integration API, FSM blockchain deployer device, app database, action service(s), rule set development tool(s), application finite state machine (FSM), components and states, process implementation machine, blockchain network component devices, data communication network devices and/or components, example buyer devices, example seller devices, example financial institution devices, example nonfungible token (NFT) devices, notification and/or authentication devices, example state machines, example shipment arrived state machine, example at customs state machine, example pay tax fees computing device, example shipment cleared computing device, example cargo departed port for in country file paperwork state machine event processor, example source device, example shipment event data receiver, example shipment event queue, example start SmartPass, example shipment in transit service, example shipment ready for customs service, example shipment action queue, example edit SmartPass Docs service, example enable doc upload service, example update SmartPass service, example shipment record database state machine, example rule engine, example rule repository, example rule editor, example engine execution core, example reporting subsystem, example SmartPass state diagram execution processors, state machines, example event data feeds, event data input layer devices, SmartPass record devices, Asset state engine devices, SmartPass State rules, rule engine execution, data output layer and action output layer devices, action event generators, after state processors, flow diagram execution processors, example state machine devices, flow diagram elements, state engines, event receiver devices, source devices, asset state devices, event queue devices, action queue devices, app asset state databases and/or services, FSM framework components, SmartHub devices, cryptocurrency exchange devices, as well as example computing devices of users, mobile devices, network communication components, routers, gateways, etc., according to an example embodiment of the present invention.

FIG. 5 depicts an exemplary schematic block diagram 500 illustrating an exemplary computer/communications device hardware architecture as may be used in various exemplary components of an exemplary embodiment including user devices various example buyer devices, example seller devices, example financial institution devices, example nonfungible token (NFT) devices, notification and/or authentication devices, example SmartHub devices, cryptocurrency exchange devices, as well as example computing devices of users, mobile devices, network communication components, routers, gateways, etc., computer device(s), bank devices, merchant devices, payment service provider devices, other computing or communications devices, routers, application servers, web servers, cloud-based computing devices, communication devices, switches, routers, gateways, telephone devices, mobile devices, content servers, web servers, database servers and/or other application servers, end-user devices, operations center devices, client and/or server devices, network routers, gateways, access points, and the like, according to various exemplary embodiments.

FIG. 5 depicts an exemplary schematic block diagram 500 illustrating an exemplary computer/communications device hardware architecture as may be used in various exemplary components of an exemplary embodiment including mobile devices, wearables, cloud-based computing devices, content servers, web servers, database servers and/or other application servers, according to various exemplary embodiments. Diagram 500 may include any of various exemplary computer systems as may be used as an external computer device, an internal and/or STB or SOC, a mobile device, a wearable, a client, or server, web server, application server, and/or any other of the computing devices included in the other drawings, according to various exemplary embodiments. FIG. 5 depicts an exemplary diagram 500 illustrating an exemplary computer/communications device hardware architecture as may be used in various components of exemplary embodiments of the present invention. FIG. 5 depicts an exemplary view 500 of exemplary computer systems such as those represented in FIGS. 1-5, 6, etc., including devices which may execute various modules, including components, systems, devices, computers, processors, mobile devices, routers, gateways, network devices, other computing and/or network devices, network monitoring and security operations data analysis computing devices which may execute various operating system and software components on such computing devices and/or subsystem devices and hardware/software modules as may be represented by devices implied by, or perform steps illustrated in various flowchart diagrams as illustrated in the figures by elements 101-113, 201-205, 500, 500, etc., as may be used in implementing an exemplary embodiment of the present invention. FIG. 5 depicts an exemplary embodiment of a computer system that may be used in computing devices including those shown and not shown, such as, e.g., but not limited to, service provider computing devices, SmartHub systems, buyer computing devices, supplier computing devices, digital financial services computing devices, public blockchain for proxy NFT computing devices, data repository processing and/or storage computing devices, network devices, communication devices, authentication devices, notification devices, requesting devices, response devices, cryptocurrency exchange related devices, NFT related devices, traditional financial services and/or fiat currency processing computing devices, electronic funds transfer (EFT) related devices, network monitoring and analysis devices of example operations illustrated example environment 600, computing devices 500, devices, servers, application servers, web servers, other wearable and/or mobile devices, sensor capture devices, routers, gateways, data network communication equipment, etc., according to an exemplary embodiment of the present invention. FIG. 5 depicts an exemplary embodiment of a computer system that may be used as client device, a server device (not shown), a network component, router, packet monitor/analyzer, server device, storage, and/or cloud based storage device, application servers, and/or web servers, etc. The present invention (or any part(s) or function(s) thereof) may be implemented using hardware, software, firmware, or a combination thereof and may be implemented in one or more computer systems or other processing systems. In fact, in one exemplary embodiment, the invention may be directed toward one or more computer systems capable of carrying out the functionality described herein. An example of a computer system 500 is shown in FIG. 5, depicting an exemplary embodiment of a block diagram of an exemplary computer system useful for implementing the present invention. Specifically, FIG. 5 illustrates an example computer 500, which in an exemplary embodiment may be, e.g., (but not limited to) a personal computer (PC) system running an operating system such as, e.g., (but not limited to) WINDOWS MOBILE™ for POCKET PC, or MICROSOFT® WINDOWS® NT/98/2000/XP/CE/7/8/10, etc. available from MICROSOFT® Corporation of Redmond, Wash, U.S.A., SOLARIS® from SUN® Microsystems of Santa Clara, Calif, U.S.A, OS/2 from IBM® Corporation of Armonk, N.Y, U.S.A, Mac/OS, Mac OSX, iOS, from APPLE® Corporation of Cupertino, Calif, U.S.A, etc., or any of various versions of UNIX® (a trademark of the Open Group of San Francisco, Calif, USA) including, e.g., LINUX®, UBUNTU, HPUX®, IBM AIX®, and SCO/UNIX®, etc., ANDROID, Android OS is available from Google, JAVA from Oracle, etc. However, the invention may not be limited to these platforms. Instead, the invention may be implemented on any appropriate computer system running any appropriate operating system. In one exemplary embodiment, the present invention may be implemented on a computer system operating as discussed herein. An exemplary computer system, computer 500 is shown in FIG. 5. Other components of the invention, such as, e.g., (but not limited to) a computing device, a communications device, a telephone, a personal digital assistant (PDA), a personal computer (PC), a handheld PC, client workstations, thin clients, thick clients, proxy servers, network communication servers, remote access devices, client computers, server computers, routers, web servers, data, media, audio, video, telephony or streaming technology servers, a tablet, a phone, a mobile phone, a cellular phone, a communications device, an iPhone, iOS, a smartphone, an iPad, a tablet based device, an ANDROID OS device, an iOS device, a Symbian based device, a Windows 8, 10, 11, etc., device, etc., may also be implemented using a computer such as that shown in FIG. 5.

The computer system 500 may include one or more processors, such as, e.g., but not limited to, processor(s) 504, which may include microprocessors, coprocessors, nanoprocessors, microcontrollers, systems on a chip (SOC), multi-processor systems, parallel processors, CISC type processors, RISC type processors, POWER type processors, ARM-architecture processors, massively parallel processor, graphic processors (GPUs) 532, cryptographic processors such as, e.g., but not limited to, encryption/decryption processor 536, quantum computers, etc. The processor(s) 504 may be connected to a communication infrastructure 506 (e.g., but not limited to, a communications bus, cross-over bar, or network, etc.). Various exemplary software embodiments may be described in terms of this exemplary computer system. After reading this description, it will become apparent to a person skilled in the relevant art(s) how to implement the invention using other computer systems and/or architectures.

Computer system 500 may include a display interface 502 that may forward, e.g., but not limited to, graphics, text, and other data, etc., from the communication infrastructure 506 (or from a frame buffer, etc., not shown) for display on the display unit 530, and/or GPU 532, and/or touchscreen 534, and/or other input or output, and/or input and output device, sensor-based device, etc.

The computer system 500 may also include, e.g., but may not be limited to, a main memory 508, random access memory (RAM), and a secondary memory 510, etc. The secondary memory 510 may include, for example, (but not limited to) a hard disk drive 512 and/or a removable storage drive 514, representing a floppy diskette drive, a magnetic tape drive, an optical disk drive, a compact disk drive CD-ROM, DVD, Personal Cloud storage, redundant array of inexpensive disks (RAID) array, etc. The removable storage drive 514 may, e.g., but not limited to, read from and/or write to a removable storage unit 518 in a well-known manner. Removable storage unit 518, also called a program storage device or a computer program product, may represent, e.g., but not limited to, a floppy disk, magnetic tape, optical disk, compact disk, etc. which may be read from and written to by removable storage drive 514. As will be appreciated, the removable storage unit 518 may include a computer usable storage medium having stored therein computer software and/or data.

In alternative exemplary embodiments, secondary memory 510 may include other similar devices for allowing computer programs or other instructions to be loaded into computer system 500. Such devices may include, for example, but not limited to, a removable storage unit 522 and an interface 520. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, FLASH memory, application specific integrated circuits (ASICs), field programmable gate arrays (FPGAs), and/or other removable storage units 522 and interfaces 520, which may allow software and/or data to be transferred from the removable storage unit 522 to computer system 500.

The computing device 500 may also include a cloud-accessible or cloud-based processing and/or storage solution as may be available from Amazon Web Services available from Amazon of Seattle, WA USA, or Azure cloud available from Microsoft Corporation of Redmond, WA USA, or Google Cloud Service available from Google of Alphabet Corporation, Mountain View, CA USA, among many other network and software communications offerings available from IBM Corporation, Oracle Corporation, and others.

Computer 500 may also include an input device such as, e.g., (but not limited to) a mouse or other pointing device such as a digitizer, touch-based sensor, and/or a keyboard and/oor other data entry device (none of which are labeled).

Computer 500 may also include output devices, such as, e.g., (but not limited to) display 530, and display interface 502. Computer 500 may include input/output (I/O) devices such as, e.g., (but not limited to) communications interface 524, cable 528 and communications path 526, etc. These devices may include, e.g., but not limited to, a network interface card, and modems (neither are labeled). Communications interface 524 may allow software and data to be transferred between computer system 500 and external devices. Examples of communications interface 524 may include, e.g., but may not be limited to, a modem, a network interface (such as, e.g., an Ethernet card), a communications port, a Personal Computer Memory Card International Association (PCMCIA) slot and card, etc. Software and data transferred via communications interface 524 may be in the form of signals 528 which may be electronic, electromagnetic, optical or other signals capable of being received by communications interface 524. These signals 528 may be provided to communications interface 524 via, e.g., but not limited to, a communications path 526 (e.g., but not limited to, a channel). This channel 526 may carry signals 528, which may include, e.g., but not limited to, propagated signals, which may be stored in nontransitory form, and may be implemented using, e.g., but not limited to, wire or cable, local and/or wide area network (LAN/WAN) protocols, Ethernet, Token Ring, FDDI, carried over andy of various physical media, fiber optics, a telephone line, twisted pair, shielded twisted pair, a cellular link, a radio frequency (RF) link, wireless communications, spread spectrum, orthogonal frequency division multiplexing (OFDM), and/or other communications channels, etc.

In this document, the terms “computer program medium” and “computer readable medium” may be used to generally refer to media such as, e.g., but not limited to removable storage drive 514, a hard disk installed in hard disk drive 512, and signals 528, etc. These computer program products may provide software to computer system 500. The invention may be directed to such computer program products.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct or indirect physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device modified as set forth herein to perform the processing as described to be selectively activated or reconfigured by a software program stored in the device to become a special purpose device capable of performing the subsystem's or submodule's performance functionality and computer and communications systems instructions, and/or by hardware processing such as, e.g., but not limited to, performing certain trusted platform system processing, including exemplary key based encryption/decryption, network monitoring, packet inspection and the like, according to exemplary embodiments.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.) when nontransitory, and others.

Computer programs (also called computer control logic), may include object-oriented computer programs, and may be stored in main memory 508 and/or the secondary memory 510 and/or removable storage units 514, also called computer program products. Such computer programs, when executed, may enable the computer system 500 to perform the features of the present invention as discussed herein. In particular, the computer programs, when executed, may enable the processor 504 to provide a method to resolve conflicts during data synchronization according to an exemplary embodiment of the present invention. Accordingly, such computer programs may represent controllers of the computer system 500.

Various artificial intelligence based analysis techniques may be used herein including neural networks, machine learning, any of various well-known AI and ML techniques and processes (e.g., reinforcement learning, dynamic programming, state action reward state action (SARSA), q learning, supervised learning, unsupervised learning, large language models (LLMs), natural language search and interactive request and response, neural networks, convolutional neural networks, statistical heuristics, topic identification and classification, linguistics and semantic processing, tensorflow and openAI libraries, cloud computing services, specific APIs, Microsoft cognitive services, Google cloud AI, Watson AI, offerings from Amazon, Facebook, Baidu, Apple, and others, etc.), and output of such algorithms may be analyzed further as set forth herein to obtain feature vectors and other data which may be used to provide further guidance to users, and/or be integrated for further processing and analysis, authentication, access control, and/or encryption/decryption processing, and coupled via decision support systems, executive information systems, and other graphical user interface enabled network and cyber security monitoring and threat analysis management and processing.

In another exemplary embodiment, the invention may be directed to a computer program product may include a computer readable medium having control logic (computer software) stored therein. The control logic, when executed by the processor 504, may cause the processor 504 to perform the functions of the invention as described herein. In another exemplary embodiment where the invention may be implemented using software, the software may be stored in a computer program product and loaded into computer system 500 using, e.g., but not limited to, removable storage drive 514, hard drive 512 or communications interface 524, etc. The control logic (software), when executed by the processor 504, may cause the processor 504 to perform the functions of the invention as described herein. The computer software may run as a standalone software application program running atop an operating system or may be integrated into the operating system.

In yet another embodiment, the invention may be implemented primarily in hardware using, for example, but not limited to, hardware components such as application specific integrated circuits (ASICs), or one or more state machines, etc. Implementation of the hardware state machine so as to perform the functions described herein will be apparent to persons skilled in the relevant art(s).

In another exemplary embodiment, the invention may be implemented primarily in firmware.

In yet another exemplary embodiment, the invention may be implemented using a combination of any of, e.g., but not limited to, hardware, firmware, and software, etc.

Exemplary embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

According to an exemplary embodiment, the application system can include an electronic decision support system (DSS) (not shown), policy-based trust platform systems, which can interact, e.g., but not limited to, with computer database management system (DBMS) 507, and/or electronic interactive, graphical user interface (GUI) system. Each of the exemplary DSS, DBMS and/or EIGUI system, can then, using e.g., but not limited to, a cryptographic processor and/or a crypto chip controller processor 536, or the like, can then encrypt the data using electronic encryptor, which can make use of one or more cryptographic algorithm electronic logic, which can include encryption code, a cryptographic combiner, etc., and may be stored in encrypted form, according to an exemplary embodiment, in a computer database storage facility, from computer database storage device, and from there the process can continue with use of the cryptographic algorithm electronic logic, and electronic decryptor, which can decrypt and/or provide a process for decrypting encrypted data, and/or by providing such data to the DSS, the DBMS, or the EIGUI, if authorized. By using encryption/decryption, certain algorithms can be used, as described herein, including, e.g., but not limited to, checksum, AES encryption, RSA, PKI, TLS, FTPS, SFTP, etc. and/or other cryptographic algorithms and/or protocols, according to exemplary embodiments.

### Cryptographic Functions

Cryptographic systems, according to an exemplary embodiment, can provide one or more of the following four example services. It is important to distinguish between these, as some algorithms are more suited to particular tasks, but not to others. To protect patient data, personal data can be encrypted prior to storage and can be decrypted before accessing the data, according to an exemplary embodiment. When analyzing requirements and risks, one needs to decide which of the four functions should be used to protect the proprietary data, according to an exemplary embodiment.

### Authentication

Using a cryptographic system, according to an exemplary embodiment, one can establish the identity of a remote user (or system). A typical example is the SSL certificate of a web server providing proof to the user device that user device is connected to the correct server, according to an exemplary embodiment.

The identity is not of the user, but of the cryptographic key of the user. Having a less secure key lowers the trust one can place on the identity, according to an exemplary embodiment.

### Non-Repudiation

The concept of non-repudiation is particularly important for financial or e-commerce applications, according to an exemplary embodiment. Often, cryptographic tools are required to prove that a unique user has made a transaction request, according to an exemplary embodiment. It must not be possible for the user to refute his or her actions, according to an exemplary embodiment.

For example, a customer can request a transfer of money from her account to be paid to another account, according to an exemplary embodiment. Later, she claims never to have made the request and demands the money be refunded to the account. If one has non-repudiation through cryptography, one can prove—usually through digitally signing the transaction request, that the user authorized the transaction.

### Confidentiality

More commonly, the biggest concern can be to keep information private, according to an exemplary embodiment. Cryptographic systems, according to an exemplary embodiment, have been developed to function in this capacity. Whether it be passwords sent during a log on process, or storing confidential proprietary financial data in a database, encryption can assure that only users who have access to the appropriate key can get access to the proprietary data.

### Integrity

One can use cryptography, according to an exemplary embodiment, to provide a means to ensure data is not viewed or altered during storage or transmission. Cryptographic hashes for example, can safeguard data by providing a secure checksum, according to an exemplary embodiment.

### Cryptographic Algorithms

Various types of cryptographic systems exist that have different strengths and weaknesses, according to an exemplary embodiment. Typically, the exemplary cryptographic systems can be divided into two classes; 1) those that are strong, but slow to run, and 2) those that are quick, but less secure. Most often a combination of the two approaches can be used, according to an exemplary embodiment (e.g.: secure socket layer (SSL)), whereby we establish the connection with a secure algorithm, and then if successful, encrypt the actual transmission with the weaker, but much faster algorithm.

### Symmetric Cryptography

Symmetric Cryptography, according to an exemplary embodiment, is the most traditional form of cryptography. In a symmetric cryptosystem, the involved parties share a common secret (password, pass phrase, or key), according to an exemplary embodiment. Data can be encrypted and decrypted using the same key, according to an exemplary embodiment. These symmetric cryptography algorithms tend to be comparatively fast, but the algorithms cannot be used unless the involved parties have already exchanged keys, according to an exemplary embodiment. Any party possessing a specific key can create encrypted messages using that key as well as decrypt any messages encrypted with the key, according to an exemplary embodiment. In systems involving a number of users who each need to set up independent, secure communication channels, symmetric cryptosystems can have practical limitations due to the requirement to securely distribute and manage large numbers of keys, according to an exemplary embodiment.

Common examples of symmetric algorithms include, e.g., but not limited to, DES, 3DES and/or AES, etc. The 56-bit keys used in DES are short enough to be easily brute-forced by modern hardware and DES should no longer be used, according to an exemplary embodiment. Triple DES (or 3DES) uses the same algorithm, applied three times with different keys giving it an effective key length of 128 bits, according to an exemplary embodiment. Due to the problems using the DES algorithm, the United States National Institute of Standards and Technology (NIST) hosted a selection process for a new algorithm. The winning algorithm was Rijndael and the associated cryptosystem is now known as the Advanced Encryption Standard or AES, according to an exemplary embodiment. For most applications 3DES, according to an exemplary embodiment, is acceptably secure at the current time, but for most new applications it is advisable to use AES, according to an exemplary embodiment.

### Asymmetric Cryptography (Also Called Public/Private Key Cryptography)

Asymmetric algorithms, according to an exemplary embodiment, use two keys, one to encrypt the data, and either key to decrypt. These inter-dependent keys are generated together, according to an exemplary embodiment. One key is labeled the Public key and is distributed freely, according to an exemplary embodiment. The other key is labeled the Private Key and must be kept hidden, according to an exemplary embodiment. Often referred to as Public/Private Key Cryptography, these cryptosystems can provide a number of different functions depending on how they are used, according to an exemplary embodiment.

The most common usage of asymmetric cryptography is to send messages with a guarantee of confidentiality, according to an exemplary embodiment. If User A wanted to send a message to User B, User A would get access to User B's publicly available Public Key, according to an exemplary embodiment. The message is then encrypted with this key and sent to User B, according to an exemplary embodiment. Because of the cryptosystem's property that messages encoded with the Public Key of User B can only be decrypted with User B's Private Key, only User B can read the message, according to an exemplary embodiment.

Another usage scenario is one where User A wants to send User B a message and wants User B to have a guarantee that the message was sent by User A, according to an exemplary embodiment. In order to accomplish this, User A can encrypt the message with their Private Key, according to an exemplary embodiment. The message can then only be decrypted using User A's Public Key, according to an exemplary embodiment. This can guarantee that User A created the message because User A is then the only entity who had access to the Private Key required to create a message that can be decrypted by User A's Public Key, according to an exemplary embodiment. This is essentially a digital signature guaranteeing that the message was created by User A, according to an exemplary embodiment.

A Certificate Authority (CA), whose public certificates are installed with browsers or otherwise commonly available, may also digitally sign public keys or certificates, according to an exemplary embodiment. One can authenticate remote systems or users via a mutual trust of an issuing CA, according to an exemplary embodiment. One can trust their ‘root’ certificates, according to an exemplary embodiment, which in turn authenticates the public certificate presented by the server.

PGP and SSL are prime examples of systems implementing asymmetric cryptography, using RSA and/or other algorithms, according to an exemplary embodiment.

### Hashes

Hash functions, according to an exemplary embodiment, take some data of an arbitrary length (and possibly a key or password) and generate a fixed-length hash based on this input. Hash functions used in cryptography have the property that it can be easy to calculate the hash, but difficult or impossible to re-generate the original input if only the hash value is known, according to an exemplary embodiment. In addition, hash functions useful for cryptography have the property that it is difficult to craft an initial input such that the hash will match a specific desired value, according to an exemplary embodiment.

MD5 and SHA-1 are common hashing algorithms, according to an exemplary embodiment. These algorithms are considered weak and are likely to be replaced in due time after a process similar to the AES selection, according to an exemplary embodiment. New applications should consider using SHA-256 instead of these weaker algorithms, according to an exemplary embodiment.

### Key Exchange Algorithms

There are also key exchange algorithms (such as Diffie-Hellman for SSL), according to an exemplary embodiment. These key exchange algorithms can allow use to safely exchange encryption keys with an unknown party, according to an exemplary embodiment.

### Algorithm Selection

As modern cryptography relies on being computationally expensive to break, according to an exemplary embodiment, specific standards can be set for key sizes that can provide assurance that with today's technology and understanding, it will take too long to decrypt a message by attempting all possible keys, according to an exemplary embodiment.

Therefore, we need to ensure that both the algorithm and the key size are taken into account when selecting an algorithm, according to an exemplary embodiment.

FIG. 6 depicts an example application server and web server network architecture including an example fully meshed, redundant communications network load balancing application server architecture as may be used for an example smarthub system service provider and/or a digital financial services and/or payment service provider, and may couple client devices such as, e.g., but not limited to, service provider, buyer devices, supplier devices, public blockchain, proxy NFT systems, data repository systems, authentication systems, ledger tracking systems, blockchain distributed ledge systems, NFT systems, SmartPass NFT authentication systems, notification systems, request response systems, financing request systems, collateralized NFT request response systems, etc. to example service devices using an example network infrastructure, according to an example embodiment of the present invention. FIG. 6 depicts an exemplary schematic block diagram 600 illustrating an exemplary communications network device hardware architecture 600 showing exemplary network devices including exemplary application server devices 602, exemplary storage devices 606, web server devices 608, all coupled to an exemplary communications network 604, which may be coupled to other devices such as, e.g., but not limited to, a cyber security network security operations environment device or devices 604, and other end user and other internal and/or external user computing and/or communications devices 610, which may be coupled to the network communications environment 604 by one or more physical devices not shown, such as, e.g., but not limited to, network interface cards (NICs), wireless local area network WLAN or wireless fidelity (WI-FI) (IEEE 802.11 communication technologies), physical wires, twisted pair, coaxial cable, fiber optic cable, and/or other communications network cabling, wireless communication access points and/or wireless antennae, wires, wireless media, routers, gateways, access points, exchange carrier facilities, modulator/demodulator (modems), modulating equipment, cellular network exchange devices, etc. Block diagram 600 may serve as an exemplary logical diagram of associated physical devices. Physical devices may communicate via one or more communications network software protocols via exemplary protocol languages or stacks which may correlate to the Open Systems Interconnect (OSI) stack of communication layers, such as, e.g., but not limited to, Internet Protocol (IP), transmission control protocol (TCP), among various other protocols including, e.g., but not limited to, TCP/IP protocols, UDP, hypertext transfer protocol (HTTP), file transfer protocol (FTP), security protocols (e.g., HTTPS, SFTP, FTPS, TLS, etc.), as will be apparent to those skilled in the relevant art. Various load sharing devices and port sharing devices may be used, as well as protocol tracing and packet tracing devices, which may be able to access such communications data and perform exemplary processing including packet inspection, deep packet inspection, network tracing, packet inspection (e.g., source and destination address, etc.) and the like. Such systems may be used to perform various block chain related distributed ledger technologies so as to replicate data which may be encrypted and decrypted using various algorithms. Certain algorithms may be used which may be resilient to conventional decryption techniques, resilient to brute force attack decryption techniques, and/or may be resilient to quantum computing based decryption techniques. Such software and hardware network analysis and/or processing tools may be used to process communications network traffic internal to, and/or external from an exemplary entity organization and an exemplary network operations center (NOC) network monitoring organization may be able to analyze such network traffic to, e.g., process different types of traffic, using various sophisticated network operations tools and techniques as well as to perform various automated processing as described further herein.

Although example embodiments of the invention are illustrated and described herein as embodied in an example embodiment, the invention should not be limited to the details shown in those example embodiments because various modifications and structural changes may be made without departing from the spirit of the invention while remaining within the scope and range of equivalents of the claims.

The construction and method of operation of various example embodiments of the claimed invention and additional features and/or advantages of various example embodiments of the invention are best understood from the following description of specific example embodiments when read in connection with the accompanying drawings.

Various exemplary embodiments of the invention are discussed in detail herein. While specific exemplary embodiments are discussed herein, it should be understood that this is done for illustration purposes only. A person skilled in the relevant art will recognize that other components and configurations can be used without parting from the spirit and scope of the invention.

What is claimed is:

1. A computer implemented method of providing a finite state machine (FSM) with business rules embedded for processing data and at least one event, comprising at least one electronic computer processor of a system coupled to at least one electronic memory storage device and coupled via at least one communications network interface to at least one data communications network, the method comprising:
individually saving, by the at least one electronic computer processor, to at least one blockchain ledger each state of a plurality of states as a data record, wherein each state comprises at least one or more of:
a unique identifier or name for the state,
a set of one or more input field names called input data slots,
the rules for the state written in a rule language, and
a set of one or more output field names called output data slots;
executing, by the at least one electronic computer processor, of a smart contract comprising at least one or more of:
processing, by the at least one electronic computer processor, for the state of the FSM by identifying the state by id or by name,
loading, by the at least one electronic computer processor, a corresponding component state from the at least one blockchain ledger, or
adding and executing, by the at least one electronic computer processor, code for processing behavior of the corresponding component state,
wherein the code comprises at least one rule for the state, written in at least one rule language.

2. The method according to claim 1, further comprising:
employing, by the at least one electronic computer processor, the at least one rule language comprising at least one rule comprising at least one or more of:
Open Policy Agent (OPA),
Rego,
Prolog,
Prolog-based DataLog,
RuleML,
Drools Rule Language (DRL),
NRules, or
JavaScript Object Notation (JSON).

3. The method according to claim 1, wherein the system comprises at least one or more of:
the at least one electronic computer processor,
at least one application program interface (API) for a user to communicate,
at least one blockchain ledger,
at least one rule processor, or
at least one electronic memory storage device.

4. A system of providing a finite state machine (FSM) with business rules embedded for processing data and at least one event, the system comprising:
at least one electronic computer processor, coupled to at least one electronic memory storage device and coupled via at least one communications network interface, coupled to at least one data communications network, the system comprising wherein said at least one electronic computer processor is configured to:
individually save to at least one blockchain ledger each state of a plurality of states as a data record, wherein the each state comprises at least one or more of:
a unique identifier or name for the state,
a set of one or more input field names called input data slots,
the rules for the state written in a rule language, and
a set of one or more output field names called output data slots;
executing of a smart contract comprising configuring the system to at least one or more of:
process for the state of the FSM by identifying the state by id or by name,
load a corresponding component state from the at least one blockchain ledger, or
add and execute code for processing behavior of the corresponding component state,
wherein the code comprises at least one rule for the state, written in at least one rule language.

5. The system according to claim 4, further comprising, wherein the system is configured to:
employ at least one rule language comprising at least one rule comprising at least one or more of:
Open Policy Agent (OPA),
Rego,
Prolog,
Prolog-based DataLog,
RuleML,
Drools Rule Language (DRL),
NRules, or
JavaScript Object Notation (JSON).

6. The system according to claim 4, wherein the system is configured to:
wherein the system comprises at least one or more of:
the at least one electronic computer processor,
at least one application program interface (API) for a user to communicate,
the at least one blockchain ledger,
at least one rule processor, or
the at least one electronic memory storage device.

7. A computer program product embodied on a computer accessible nontransitory storage medium, including at least one instruction, which when executed on at least one electronic computer processor performs a method of providing a finite state machine (FSM) with business rules embedded for processing data and at least one event, comprising at least one electronic computer processor coupled to at least one electronic memory storage device and coupled via at least one communications network interface to at least one data communications network, the method comprising:
individually saving to at least one blockchain ledger each state of a plurality of states as a data record, wherein each state comprises at least one or more of:
a unique identifier or name for the state,
a set of one or more input field names called input data slots,
the rules for the state written in a rule language, and
a set of one or more output field names called output data slots;
executing of a smart contract comprising at least one or more of:
processing for the state of the FSM by identifying the state by id or by name,
loading a corresponding component state from the at least one blockchain ledger, or
adding and executing code for processing behavior of the corresponding component state,
wherein the code comprises at least one rule for the state, written in at least one rule language.

8. The computer program product according to claim 7, wherein the method further comprises:
employing at least one rule language comprising at least one rule comprising at least one or more of:
Open Policy Agent (OPA),
Rego,
Prolog,
Prolog-based DataLog,
RuleML,
Drools Rule Language (DRL),
NRules, or
JavaScript Object Notation (JSON).

9. The computer program product according to claim 7, wherein the method comprises; and
wherein the system comprises at least one or more of:
the at least one electronic computer processor,
at least one application program interface (API) for a user to communicate,
the at least one blockchain ledger,
at least one rule processor, or
the at least one electronic memory storage device.

10. The method according to claim 1, wherein the method comprises providing at least one or more of:
transparency,
immutability, or
secure execution of business rules
within a FSM architecture.

11. The system according to claim 4, wherein the system is configured to provide at least one or more of:
transparency,
immutability, or
secure execution of business rules
within a FSM architecture.

12. The computer program product according to claim 7, wherein the method comprises providing at least one or more of:
transparency,
immutability, or
secure execution of business rules
within a FSM architecture.
